(19) United States
(12) Patent Application Publication
(10) Pub. No.: US 2014/0040879 A1
(43) Pub. Date: Feb. 6, 2014

(54) INTERMEDIATE APPLICATION INSTALLATION FILE

(71) Applicant: Oliver Goldman, Redwood City, CA (US)

(72) Inventor: Oliver Goldman, Redwood City, CA (US)

(73) Assignee: ADOBE SYSTEMS INCORPORATED, San Jose, CA (US)

(21) Appl. No.: 12/029,378

(22) Filed: Feb. 11, 2008

(51) Int. Cl. G06F 9/445

(52) U.S. Cl. 717/175

(57) ABSTRACT

Methods, systems, and apparatus, including medium-encoded computer program products, for effecting software installation. In one aspect, a method includes specifying a first file type for application installation files for an application execution environment, and specifying a second file type for application distribution files corresponding to the application installation files, wherein an application installation file of the first file type includes a software application, the application installation file must be digitally signed for the software application to be installed in the application execution environment from the application installation file, and wherein an application distribution file of the second file type includes the software application, the software application is not installable in the application execution environment from the application distribution file, and the application distribution file is convertible to the first file type through at least addition of a digital signature.

### BACKGROUND

The present disclosure relates to installing software on a computer platform. A computer platform is a computer including a particular operating system (OS) for that computer (e.g., WINDOWS® OS, MAC® OS, or LINUX® OS). Software developers often create source code that can be appropriately compiled for respective computer platforms, and then independently generate native installation packages for each target platform. Each native installation package is associated with a specific computer platform, and these native installation packages can then be distributed for installation on appropriate machines. For a particular target platform, the appropriate native installation package is obtained from the software developer, and an OS installer can be used to process the native installation package in order to install the application. For example, INSTALLSHIELD® software can be used to produce .msi files for installation on WINDOWS® machines, and a different software tool can be used to produce .pkg files for installation on MAC® machines.

Some software developers have created cross-platform installation packages, such as the JAVA® Archive (JAR) file format, that get deployed to the end-user system. The cross-platform package can then be expanded (e.g., decrypted and uncompressed) and written directly to disk using code provided by the software developer and/or the developer of the cross-platform package format. Typically, such cross-platform software relies on a virtual machine, such as the JAVA® Virtual Machine (JVM) (available from Sun Microsystems, Inc.), to run on the target platform. The JVM provides a runtime environment and Java interpreter for most operating systems, including WINDOWS® OS, MAC® OS, AND LINUX® OS. Other runtime environments include FLASH® Player and ADOBE® AIR™ software, both available from Adobe Systems Incorporated of San Jose, Calif.

In addition, some install file formats support digital signatures. Typical file formats for distribution of signed code include WINDOWS® executables employing AUTHENTICODE® software, WINDOWS® installer files (MSI), and JAR files. In each of these formats, a valid installation file may be either signed or unsigned. Thus, a software developer can create the file and then hand it off to the signer for a separate digital signing step, but both the unsigned version and the signed version of the file can be used in the installation process.

### SUMMARY

This specification describes technologies relating to software installation. In general, one or more aspects of the subject matter described in this specification can be embodied in one or more methods that include specifying a first file type for application installation files for an application execution environment, and specifying a second file type for application distribution files corresponding to the application installation files, wherein an application installation file of the first file type includes a software application, the application installation file must be digitally signed for the software application to be installed in the application execution environment from the application installation file, and wherein an application distribution file of the second file type includes the software application, the software application is not installable in the application execution environment from the application distribution file, and the application distribution file is convertible to the first file type through at least addition of a digital signature. Other embodiments of this aspect include corresponding systems, apparatus, and computer program products.

These and other embodiments can optionally include one or more of the following features. The method(s) can include receiving the application distribution file, where the specifying the second file type can include identifying the application distribution file as belonging to the second file type, and the specifying the first file type can include converting the application distribution file from the second file type to the first file type to form the application installation file. The converting can include changing file type information for the application distribution file, and generating the digital signature for the application distribution file. Moreover, changing file type information can include changing embedded content type information and file extension information for the application distribution file.

The converting can include unpackaging files of the software application from the application distribution file, and repackaging the files of the software application into the application installation file, which is separate from the application distribution file being processed. The method(s) can include receiving input indicating files of the software application to be packaged together, determining whether digital signing is to occur with packaging, where the specifying the first file type can include packaging the files of the software application in the application installation file when digital signing is to occur with packaging, and the specifying the second file type can include packaging the files of the software application in the application distribution file when digital signing is not to occur with packaging.

In addition, the application execution environment can include a cross-platform runtime environment, and the method(s) can include receiving, in the cross-platform runtime environment, a designated file, where the specifying the first file type and the specifying the second file type can include determining, in the cross-platform runtime environment, to which type the designated file belongs. The method(s) can further include allowing installation of the software application from the designated file when the designated file belongs to the first file type, and preventing installation of the software application from the designated file when the designated file belongs to the second file type.

The method(s) can be implemented in computer program product(s), encoded on computer-readable media, operable to cause data processing apparatus to perform the operations of the method(s). Moreover, a system implementation can include a first computer including a packaging tool programmed to convert an application distribution file, which includes multiple files of a software application, to an application installation file through at least addition of a digital signature; and a second computer including an application execution environment and an installation tool programmed to install the software application from the application installation file only if a digital signature of the application installation file is present and valid, and to prevent installation of the software application from the application distribution file.

The first computer can include the packaging tool programmed to change file type information and generate the digital signature to convert the application distribution file to the application installation file. The first computer can include the packaging tool programmed to change embedded content type information and file extension information. The first computer can include the packaging tool programmed to unpackage files of the software application from the application distribution file and repackaging the files of the software application into the application installation file, which is separate from the application distribution file being processed. Moreover, the first computer can include the packaging tool programmed to receive input indicating files of the software application to be packaged together, determine whether digital signing is to occur with packaging, package the files of the software application in the application installation file when digital signing is to occur with packaging, and package the files of the software application in the application distribution file when digital signing is not to occur with packaging.

Particular embodiments of the subject matter described in this specification can be implemented to realize one or more of the following advantages. The security of software application distribution can be improved. A digital signature can be required for application installation packages, and application distribution packages can be used to send packaged applications to the signer that creates the corresponding installation packages by applying a digital signature. The application distribution packages can be substantially similar to the application installation packages, but are not installable. Thus, the risk of an unsigned version of an application distribution file being used to install the application can be substantially eliminated. Moreover, the workflow in an application distribution system that requires digital signatures for application installation packages can be improved, since the packaging and signing operations can be performed separately.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows application installation workflows using an intermediate file.

FIG. 2 shows example data processing apparatus including a software development kit and an application execution and installation environment.

FIG. 3 shows an example application installation workflow.

FIG. 4 shows an example process of packaging files of a software application.

FIG. 5 shows an example process of creating an application installation file.

FIG. 6 shows an example process of converting an application distribution file into an application installation file.

FIG. 7 shows an example process of handling application distribution and application installation files.

Like reference numbers and designations in the various drawings indicate like elements.

### DETAILED DESCRIPTION

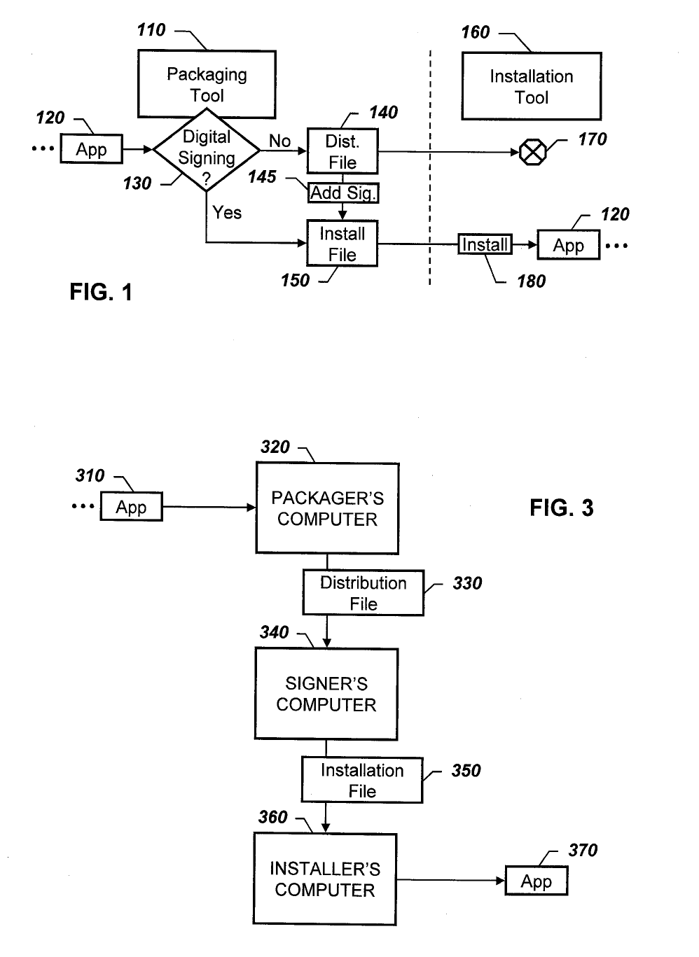

FIG. 1 shows application installation workflows using an intermediate file. A packaging tool 110 can take a set of application files 120 and combine them to form a single file for distribution. The set of application files 120 can include files containing source code, machine code, libraries, data, documentation, configuration information, icons, or any other resources that can be used by an application and the installation procedure for that application. Portions of the set of application files 120 can be platform dependent or independent.

As used herein, the term “application” refers to a computer program that the user perceives as a distinct computer tool, which is used for a defined purpose. In general, an application relies on an application execution environment to operate, where an application execution environment can include an operating system (OS) and/or a cross-platform runtime environment that sits above an OS. For example, an application can be an AIR™ application, which can be created using various types of source files, such as SWF (Shockwave Flash) files, HTML (HyperText Markup Language) files, JavaScript files, JPEG (Joint Photographic Experts Group) files, etc.

The single file (the application package) created by the packaging tool 110 from the set of application files 120 can include package information and program content. The package information can include information useable in an installation sequence, which can be stored in eXtensible Markup Language (XML). For example, the application package can be stored as a compressed and/or encrypted file (e.g., a Zip file), and the package information can be stored in an XML file included within the compressed and encrypted file. This XML file can contain information used during installation, such as the application name, the application version, publisher name, an icon for the application (e.g., in .png format), a default installation directory, file extensions registered by the application, and Multipurpose Internet Mail Extensions (MIME) content types registered by the application. Moreover, this XML file can contain one or more references to the information used during installation, rather than the actual data itself, in which case these reference(s) also constitute information useable in an installation sequence. In general, the package information can include a description of all the items an installation sequence uses, and the program content can include (or reference) the resources used to form the application.

When creating the application package, the packaging tool determines 130 whether the package will be digitally signed. If not, a distribution file 140 can be created. If so, an installation file 150 can be created. Both the distribution file 140 and the installation file 150 constitute an application package. However, only the installation file 150 can be used to install the application on a target computer.

An installation tool 160, located on a target computer, requires that an application package be digitally signed to be installable. The installation tool 160 checks for a valid digital signature before it will install a software application included in an application package. Thus, since the distribution file 140 is not signed, the distribution file 140 cannot be installed 170 by the installation tool 160. In contrast, a validly signed installation file 150 can be installed 180 by the installation tool 160.

Nonetheless, the distribution file 140 can include all the same information as that included in the installation file 150 (excepting a digital signature). Moreover, the distribution file 140 can be turned into the installation file 150 by adding a digital signature 145. Thus, the distribution file 140 has a different file type from that of the installation file 150, even if that difference in file type is only recognized by the packaging tool 110 and the installation tool 160 (i.e., the difference is determined by the presence or absence of a digital signature). The distribution file 140 thus represents an intermediate file used for distributing an unsigned application package in a computing system where application packages must be digitally signed to be installable. In general, the two files 140, 150 correspond to a pair of file formats that need be separated only by the presence or absence of the digital signature, and the packaging tool 110 and the installation tool 160 specify the two file types by handling them differently, in accordance with the limitations imposed on each file type.

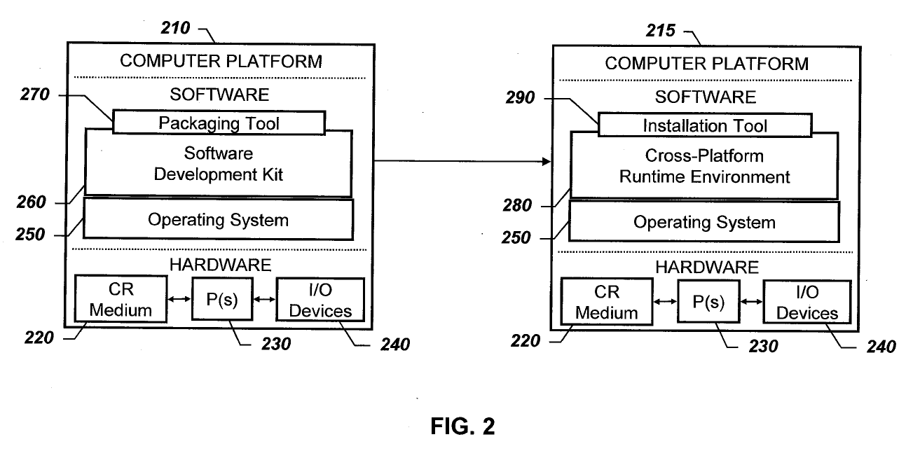

FIG. 2 shows example data processing apparatus including a software development kit and an application execution and installation environment. Separate computer platforms 210, 215 each include both hardware and software. The hardware includes input/output devices 240, one or more processors 230 and at least one computer readable medium 220 (e.g., memory device(s), a storage device(s), or combinations of one or more of them). Moreover, the software includes an operating system 250, which may be different on the respective computers.

The application distributor's computer 210 includes a software development kit 260, which includes (or is linked with) a packaging tool 270, such as described above. For example, the software development kit 260 can include various application development frameworks and/or web development tools, such as FLEX™ BUILDER™ software and DREAMWEAVER® software available from Adobe Systems Incorporated of San Jose, Calif. These software tools can be used to create a cross-platform application, such as an AIR™ application, and the packaging tool 270 can be used to create the application package, which is sent to the user's computer 215.

The user's computer 215 includes a cross-platform runtime environment 280, such as the ADOBE® AIR™ software available from Adobe Systems Incorporated of San Jose, Calif. The cross-platform runtime environment 280 uses the operating system 250 on the user's computer 215 to interact with other elements of the computer 215. The runtime environment 280 can provide various utility services for use by applications that run in the environment. These utility services can include file system access, window and menuing, integration with the OS shell (e.g., WINDOWS® OS Explorer or MAC® OS Finder), file extension registration, document processing support (e.g., Hypertext Markup Language (HTML) and Portable Document Format (PDF) engines), string manipulation, graphics, networking, notification facilities, addressing peripherals, or other types of functionality that can be provide using a runtime library. Moreover, the runtime environment 280 can include a cross-platform application program interface (API) that provides services to applications that run in the runtime environment and serves to abstract away details of the various hardware and OS platforms on which the runtime environment program 280 has been designed to run.

In addition to serving as an application execution environment, the runtime environment 280 can also serve as an application installation environment for the applications that run in the runtime environment 280. Thus, the runtime environment 280 can include (or be linked with) an installation tool 290, such as described above. By specifying the different file types (i.e., application distribution file and application installation file) and enforcing the limitations imposed on each file type, the packaging tool 270 and the installation tool 290 can support workflows that separate the packaging of an application's resources from the digital signing of those resources, thus allowing those two operations (packaging and signing) to be assigned to different entities at different times.

FIG. 3 shows an example application installation workflow, where packaging and signing are separate. A set of application files 310 can be packaged at a packager's computer 320 to form a distribution file 330. The distribution file 330 can be sent to a signer's computer 340, where the distribution file can be converted to an installation file 350 by applying a digital signature (and potentially additional operations as described further below). The installation file 350 can be sent to an installer's computer 360, where an application 370 can be installed from the installation file 350.

An advantage of this workflow is that packaging and signing can be readily kept separate, while also requiring that an application package be digitally signed to be installable. In many cases, the digital certificates that are to be used when signing the application package are so important that only a very small number of people have access to them. Such digital certificates are often physically secured (e.g., stored on hardware devices behind locked doors), and the people who do have access to the certificates are frequently unfamiliar with the application packaging process. Thus, the separated workflow allows the appropriate people to handle the packaging and signing operations at the appropriate time.

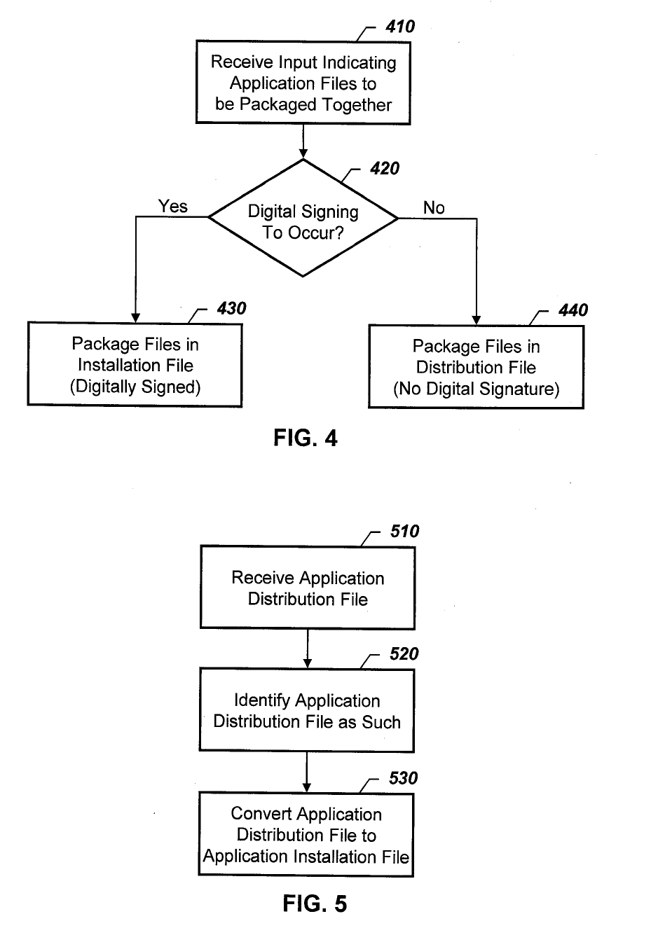

FIG. 4 shows an example process of packaging files of a software application. Initially, input indicating files of the software application to be packaged together is received 410. This input can be user input or input generated automatically by a computer in response to other input (e.g., as part of a batch operation). A check is made to determine 420 whether digital signing is to occur with packaging. This can be based on the received input, a current state of operation, or other received input.

If digital signing is to occur, the files of the software application are packaged 430 together in a digitally signed installation file. The application files are packaged into a single file, and the single file is digitally signed. The signature can be computed as the packaging proceeds. For example, for each application file encountered, a hash over the file can be computed, and once all the hashes have been computed, these can be used to compute the digital signature. Note also that during the packaging, various application files can also be compressed, including selective file compression based on whether the compressed file is substantially reduced in size from the uncompressed file.

Furthermore, a hash of the files that are in the package can be stored in the package, where this hash is not part of the signature. This hash is not an encrypted hash, but rather a hash used to identify the package. Thus, two package files can be quickly compared, to see if they are the same package (i.e., no changes have been made), by comparing the hash identifiers stored therein. This can improve operational efficiency at install time.

If digital signing is not to occur, the files of the software application are packaged 440 together in an unsigned distribution file. This distribution file can also include compressed files as in the installation file and can include all the packaging information used for the installation file, but the distribution file is a different file type (e.g., no digital signature, different file extension and different MIME content type). The purpose of the distribution file is to be consumed by the tool that can go back through the same packaged content and create an installation file there from by applying a digital signature.

In general, the distribution file can be identical to the installation file, with the exception of the digital signature. The signature format can be based on the XML-Signature Syntax and Processing W3C (World Wide Web Consortium) Recommendation 12 Feb. 2002 (http://www.w3.org/TR/xmldsig-core/). Other approaches can also be used. Both the distribution file and the installation file can contain any appropriate application content for the package. Such content can be packaged into both files using rules that govern the names and the structures used, which rules can help to ensure cross-platform compatibility in the case of a cross-platform package. The rules can specify where various types of information are added to the package, including the digital signature information, which can be stored under a specified name that cannot be used for anything else.

In general, two kinds of rules can be used to organize information in the package. First, content specific to the application being packaged can be separated from content required by the runtime. Thus, for example, runtime-specific files can be put into a subdirectory in the package reserved for that use. Other schemes can of course be used. Second, some runtime-specific files, including the digital signature, can be assigned a name which is the same as the equivalent file in related packaging formats. This enables the creation of applications that can, for example, examine signature information in all packages conforming to these naming rules, regardless of whether or not they are installation or distribution files. Various different sets of rules can be used in this manner and still achieve the same result.

In addition, the JAVA® Virtual Machine can be leveraged to support multiple different ways of storing the keys that are used for signing. The keys can be stored in a file on disk, in the OS keystore, or in a hardware device. Thus, this capability can leverage the Java Cryptography Architecture (JCA).

Furthermore, access to the packaging functionality can be provided in multiple ways. An API can be called to access the functions. A command line tool can be used to access the functions. A dialog in a visual development tool, such as FLEX™ BUILDER™ software, can be used to create the application package, where the dialog can include a check box that indicates whether one is creating a signed file for installation or an intermediate file that will be signed later. Note that all three approaches can be provided in the same packaging tool.

FIG. 5 shows an example process of creating an application installation file from an application distribution file. When the application distribution file is received 510, it is identified 520 as such. This identification can be based on file type information and the lack of a digital signature being present. Once the received file has been confirmed as an application distribution file, it can be converted 530 to an application installation file. This can involve applying a digital signature and also, potentially, additional operations as described further below. Note that the file format conversion functionality can also be provided in three ways: API calls, use of a command line tool, and use of a dialog in a visual development tool.

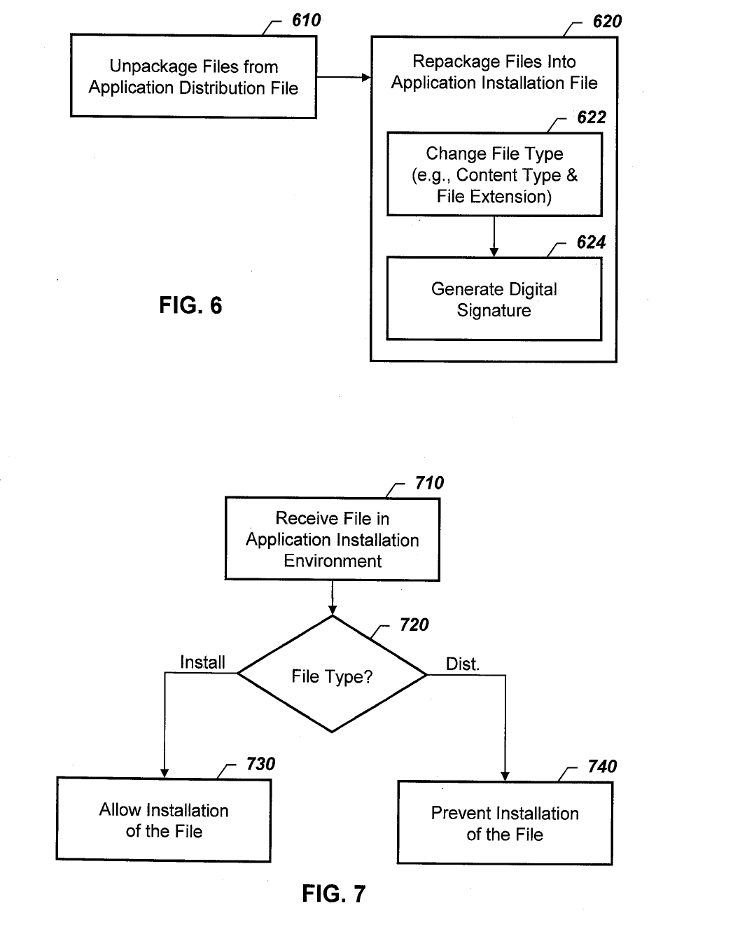

FIG. 6 shows an example process of converting an application distribution file into an application installation file. The application distribution file can be unpackaged 610. Each file can be taken, one-by-one, out of the package, and the hash for each file can be computed (after possibly decompressing it). The files can be repackaged 620 into the application installation file, such as described above in connection with FIG. 4.

File type information for the application distribution file can be changed 622 to form the application installation file. This can involve changing embedded content type information (e.g., changing the MIME content type) and changing file extension information for the application distribution file. However, in general, changing the type of the file doesn't require changing both the file extension and the embedded content type information. In some implementation, only the file extension need be changed (note that usually the extension is not considered part of the file, but rather is the name of the file in the file system). In other implementations, only the embedded content type information need be changed. There are other ways to specify the type of a file as well. Nonetheless, changing both the file extension and embedded file type information can be advantageous in some implementations since it helps to ensure that application developers and users will not confuse the distribution file with the installation file.

In addition, the digital signature for the application distribution file is generated 624 for addition to the application installation file. This can be done as described above in connection with FIG. 4. Furthermore, an identifier hash can also be computed and added to the application installation file during the digital signing operation, as described above in connection with FIG. 4.

Creating the application installation file from the application distribution file by unpackaging the application distribution file and repacking the application files into a new, separate application installation file can result in certain efficiencies in terms of implementation. It will be appreciated that an alternative approach is to modify the existing application distribution file in place to create the application installation file. In such cases, when the digital signature is not just tacked on to the end of the file, once the digital signature has been fully computed, the process can back up the right amount, and then start overwriting data in the distribution file to add the digital signature. Then the process can re-stitch the end of the file back on to the distribution file to complete the formation of the installation file.

FIG. 7 shows an example process of handling application distribution and application installation files. A file is received 710 in an application installation environment, which can be part of a cross-platform runtime environment, as described above. A check is made 720 to determine whether the received file is an application distribution file or an application installation file. This involves checking for (and validating) any digital signature that is present. Thus, an application distribution file cannot be changed into an application installation file by simply changing the file extension in the file system.

If the file is an installation file, the application installation environment allows 730 installation of the software application from the received file. If the file is an application distribution file, the application installation environment prevents 740 installation of the software application from the received file. Note that the application distribution file can include all the information needed for installing the software application, but since the application installation environment checks the file for the digital signature, one cannot install the application from the distribution file.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a cross-platform runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, one could use “generic” tools, not suited for this particular purpose, to accomplish the implementation, such as by doing the packaging with a generic zip utility, instead of with a utility specific to creating installation and distribution files.

What is claimed is:

1. A computer-implemented method comprising:
specifying, by a computer, a first file type for application installation files for an application execution environment; and
specifying, by the computer, a second file type for application distribution files corresponding to the application installation files;
wherein an application installation file of the first file type includes a software application, the application installation file must be digitally signed for the software application to be installed in the application execution environment from the application installation file; and
wherein an application distribution file of the second file type includes the software application, the software application is not installable in the application execution environment from the application distribution file, and the application distribution file is convertible to the first file type through at least addition of a digital signature from a signer computer, the signer computer being separate from the computer.

2. The method of claim 1, comprising:
receiving the application distribution file;
the specifying the second file type comprises identifying the application distribution file as belonging to the second file type; and
the specifying the first file type comprises converting the application distribution file from the second file type to the first file type to form the application installation file.

3. The method of claim 2, wherein the converting comprises:
changing file type information for the application distribution file; and
generating the digital signature for the application distribution file.

4. The method of claim 3, wherein the changing file type information comprises changing embedded content type information and file extension information for the application distribution file.

5. The method of claim 3, wherein the converting comprises:
unpackaging files of the software application from the application distribution file: and
repackaging the files of the software application into the application installation file, which is separate from the application distribution file being processed.

6. The method of claim 1, comprising:
receiving input indicating files of the software application to be packaged together;
determining whether digital signing is to occur with packaging;
the specifying the first file type comprising packaging the files of the software application in the application installation file when digital signing is to occur with packaging; and
the specifying the second file type comprises packaging the files of the software application in the application distribution file when digital signing is not to occur with packaging.

7. The method of claim 1, wherein the application execution environment comprises a cross-platform runtime environment, the method comprising:
receiving, in the cross-platform runtime environment, a designated file;
the specifying the first file type and the specifying the second file type comprising determining, in the cross-platform runtime environment, to which type the designated file belongs;
allowing installation of the software application from the designated file when the designated file belongs to the first file type; and
preventing installation of the software application from the designated file when the designated file belongs to the second file type.

8. A computer program product, encoded on a non-transitory computer-readable medium, operable to cause data processing apparatus to perform operations comprising:
specifying a first file type for application installation files for an application execution. environment; and
specifying a second file type for application distribution files corresponding to the application installation files;
wherein an application installation file of the first file type includes a software application, the application installation file must be digitally signed for the software application. to be installed in the application execution environment from the application installation file; and
wherein an application distribution file of the second file type includes the software application, the software application is not installable in the application execution environment from the application distribution file, and the application distribution file is convertible to the first file type through at least addition of a digital signature from a signer computer, the signer computer being separate from the data processing apparatus.

9. The computer program product of claim 8, the operations comprising:
receiving the application distribution file;
the specifying the second file type comprises identifying the application distribution file as belonging to the second file type, and
the specifying the first file type comprises converting the application distribution file from the second file type to the first file type to form the application installation file.

10. The computer program product of claim 9, wherein the converting comprises:
changing file type information for the application distribution file; and
generating the digital signature for the application distribution file.

11. The computer program product of claim 10, wherein the changing file type information comprises changing embedded content type information and file extension information for the application distribution file.

12. The computer program product of claim 10, wherein the converting comprises:
unpackaging files of the software application from the application distribution file; and
repackaging the files of the software application into the application installation file, which is separate from the application distribution file being processed.

13. The computer program product of claim 8, the operations comprising:
receiving input indicating files of the software application to be packaged together;
determining whether digital signing is to occur with packaging;
the specifying the first file type comprising packaging the files of the software application in the application installation file when digital signing is to occur with packaging; and
the specifying the second file type comprises packaging the files of the software application in the application distribution file when digital signing is not to occur with packaging.

14. The computer program product of claim 8, wherein the application execution environment comprises a cross-platform runtime environment, the method comprising:
receiving, in the cross-platform runtime environment, a designated file;
the specifying the first file type and the specifying the second file type comprising determining, in the cross-platform runtime environment, to which type the designated file belongs;
allowing installation of the software application from the designated file when the designated file belongs to the first file type; and
preventing installation of the software application from the designated file when the designated file belongs to the second file type.

15. A system comprising:
a packager computer configured to package an application distribution file;
a first computer including a packaging tool programmed to convert the application distribution file, which includes multiple files of a software application, to an application installation file through at least addition of a digital signature; and
a second computer including an application execution environment and an installation tool programmed to install the software application from the application installation file only if a digital signature of the application installation file is present and valid, and to prevent installation of the software application from the application distribution file.

16. The system of claim 15, the first computer including the packaging tool programmed to change file type information and generate the digital signature to convert the application distribution file to the application installation file.

17. The system of claim 16, the first computer including the packaging tool programmed to change embedded content type information and file extension information.

18. The system of claim 16, the first computer including the packaging tool programmed to unpackage files of the software application from the application distribution file and repackaging the files of the software application into the application installation file, which is separate from the application distribution file being processed.

19. The system of claim 15, the first computer including the packaging tool programmed to receive input indicating files of the software application to be packaged together, determine whether digital signing is to occur with packaging, package the files of the software application in the application installation file when digital signing is to occur with packaging, and package the files of the software application in the application distribution file when digital signing is not to occur with packaging.

20. The system of claim 15, wherein the application execution environment comprises a cross-platform runtime environment including the installation tool.
